(19) United States
(12) Patent Application Publication
(10) Pub. No.: US 2012/0188895 A1
(43) Pub. Date: Jul. 26, 2012

(54) SYSTEM AND METHOD FOR SUPPORTING LOCAL IP CONNECTIVITY FOR AN (E)NODEB

(75) Inventors: Gottfried Punz, Dossenheim (DE); Stefan Schmid, Heidelberg (DE)

(73) Assignee: NEC EUROPE LTD., Heidelberg (DE)

(21) Appl. No.: 13/390,182

(22) PCT Filed: Aug. 13, 2010
(86) PCT No.: PCT/EP2010/004977

§ 371 Date: Apr. 2, 2012

(30) Foreign Application Priority Data
Aug. 13, 2009 (EP) 09010472.0

(51) Int. Cl. H04L 12/26; H04W 4/00

(52) U.S. Cl. 370/252; 370/328

(57) ABSTRACT

A system for supporting local IP connectivity for an (e)NodeB, the system including a mobile operator network with a PDN-Gateway or a GGSN, and at least one User Equipment (UE) that is associated with the (e)NodeB, is characterized in that a local gateway function (L-GW) is provided for the (e)NodeB, wherein an extension tunnel is established between the local gateway function (L-GW) and the PDN-Gateway or the GGSN of the mobile operator network. Furthermore, a corresponding system is disclosed.

The present invention relates to a system for supporting local IP connectivity for an (e)NodeB, said system including a mobile operator network with a PDN-Gateway or a GGSN, and at least one User Equipment (UE) that is associated with said (e)NodeB.

Furthermore, the present invention relates to a method for supporting local IP connectivity for an (e)NodeB, in particular for being executed in a system according to any of claims 1 to 20, wherein a mobile operator network with a PDN-Gateway or a GGSN is provided, and wherein at least one User Equipment (UE) is associated with said (e)NodeB.

In 3GPP there is ongoing, intensive search for architectural enhancements to efficiently support local IP connectivity. Currently such local IP connectivity is briefly denoted as LIPA (Local IP Access), in case the traffic is directed to a UE's (User Equipment) home network, or as SIPTO (Selected IP Traffic Offload), in case the traffic is directed towards the Internet. The 3GPP efforts are directed both to the home cell and the macro cell scenarios, and for EPS (see for reference 3GPP TS 23.401 V8.6.0 (2009-06), “General Packet Radio Service (GPRS) enhancements for Evolved Universal Terrestrial Radio Access Network (E-UTRAN) access”) and 3G GPRS (see for reference 3GPP TS 23.060 V8.5.1 (2009-06), “General Packet Radio Service (GPRS);Service description”). 3GPP SA2 has started normative work already according to S2-094867, “New WID for Local IP Access & Internet Offload”. The present invention builds on assumptions and principles defined in these specifications and documents and related specifications, as will be explained in more detail below.

IP connectivity for a UE towards an external (target) PDN (Packet Data Network) in the current state of the art of mobile network technology is provided by the PDN Gateway in the mobile network operator's core network. Mobility tunnels carry the traffic via the (e)NodeB and Serving-Gateway. Similarly, in GPRS scenarios IP connectivity is provided by the GGSN (Gateway GPRS Support Node) that corresponds to the PDN gateway in LTE scenarios. Further, in UTRAN radio access (3G) mobility tunnels carry the traffic via the NodeB, the RNC (Radio Network Controller) and the SGSN (Serving GPRS Support Node).

The general problem is that the amount of plain, “dumb” Internet traffic, or traffic to local servers (e.g. in the home or enterprise network) is expected to grow considerably in the future. This type of traffic should not require value-added resources of the 3GPP operator, and consequently should be offloaded from his network as soon as possible. One possible location for IP traffic breakout is at the (e)NodeB.

Current state of the art has the concept of APN (Access Point Name), which allows to separate traffic. The APN takes the form of a FQDN (Fully Qualified Domain Name) and is resolved ultimately to an IP address. In current discussions in standardization it is mostly assumed that for LIPA/SIPTO traffic a separate APN is used; requirements have also been stated that one common APN may be used for LIPA/SIPTO and non-LIPA/SIPTO type of traffic. No concrete solution for this has been given. The common APN for both types of traffic is assumed to apply mostly for local IP traffic to the Internet (SIPTO).

It is an object of the present invention to improve and further develop a system and a method for supporting local IP connectivity for an (e)NodeB of the initially described type in such a way that, by employing mechanisms that are readily to implement, efficiently enables local IP access (breakout) with minimal impact on existing EPS (Evolved Packet System) or 3G-GPRS standards.

In accordance with the invention, the aforementioned objective is accomplished by a system comprising the features of claim 1. According to this claim such a system is characterized in that a local gateway function (L-GW) is provided for said (e)NodeB, wherein an extension tunnel is established between said local gateway function (L-GW) and said PDN-Gateway or said GGSN of said mobile operator network.

Furthermore, the aforementioned object is accomplished by a method comprising the features of independent claim 21. According to this claim, such a method is characterized in that a local gateway function (L-GW) is provided for said (e)NodeB, wherein an extension tunnel is established between said local gateway function (L-GW) and said PDN-Gateway or said GGSN of said mobile operator network.

According to the invention it has first been recognized that the best location for IP traffic breakout is at the (e)NodeB. Furthermore, it has been recognized that local IP connectivity for an (e)NodeB can be effectively supported by means of combining a new functional entity, denoted local gateway function -L-GW-, that is provided for the (e)NodeB, together with a tunnelling mechanism to/from the PDN-Gateway or the GGSN, respectively, of the mobile operator network.

By combining a local gateway function and an extension tunnel according to the present invention all steps carried out for supporting local IP connectivity are entirely transparent for the user equipment, which does not realize the establishment of the extension tunnel at all. This is in strong contrast to overlay approaches like VPN (Virtual Private Network), for instance, in which the UE is actively involved.

The proposed solution requires only a minimal architectural extension of 3GPP standardized architecture, either EPS or GPRS. In other words, the architecture according to the present invention reuses as much as possible the current (3GPP Rel. 8) architecture and extents it smoothly.

According to a preferred embodiment the extension tunnel may be terminated in the PDN-Gateway or the GGSN, respectively, as endpoint. Such architecture requires only minimal changes with the PDN-Gateway or the GGSN, without the need for providing any additional entity.

Alternatively, it may be provided that the extension tunnel is terminated in a functional entity outside of the PDN-Gateway or the GGSN, wherein that functional entity interfaces with the PDN-Gateway or the GGSN, respectively. This embodiment may apply in special cases and comes along with the advantage that the changes required with the PDN-Gateway or the GGSN, respectively, are further minimized. Consequently, with respect to integrating the proposed solution into existing standardized systems this embodiment is particularly favourable.

According to an implementation with low control requirement it may be provided that the extension tunnel is established each time a connection is established between the User Equipment and the PDN-Gateway (or the GGSN, respectively) via the (e)NodeB. On the other hand, in order to avoid unnecessary tunnel establishments, it may be provided that the PDN-Gateway (or the GGSN, respectively) is equipped with a decision function that analyzes predefined criteria for local traffic and performs extension tunnel establishment only in cases in which the User Equipment establishes a connection to packet data networks with APNs that match that predetermined criteria for local traffic.

With respect to an economized resource usage it may be provided that a single extension tunnel between the L-GW and the PDN-Gateway/GGSN is established for several UEs.

Advantageously, the L-GW is collocated with the (e)NodeB, but this invention is equally applicable to scenarios where the L-GW is located on a separate entity from the (e)NodeB. The (e)NodeB may either be a Home (e)NodeB or a Macro-cell (e)NodeB, however, the main benefits of the proposed solution and the wider scope of application scenarios result for Home (e)NodeBs.

According to a preferred embodiment the local gateway function includes the functionality of routing traffic to and from external packet data networks. In particular, this means that traffic from the User Equipment is routed directly to external networks, e.g. the Internet, enterprise and/or home networks, without the traffic passing the PDN-Gateway or the GGSN, respectively.

Furthermore, the local gateway function may include the functionality of tunnelling IP packets through the extension tunnel to and from the PDN-Gateway or GGSN, respectively. In particular, the tunnel is employed in two specific situations: First, in case downlink traffic arrives at the local gateway function while the User Equipment is in idle mode, and, second, in cases in which the User Equipment had performed a handover to another (e)NodeB. The tunnelling of IP packets may be based on, for instance, GTP (GPRS Tunnelling Protocol), PMIP (Proxy Mobile IP), or IP in IP.

According to a specific embodiment it may be provided that the local gateway function allocates an IP address to the User Equipment and conveys the allocated IP address to the PDN-Gateway/GGSN. Alternatively, it may be provided that the PDN-Gateway/GGSN allocates an IP address to the User Equipment, which is then conveyed to the local gateway function. The local gateway function may then perform a Network Address Translation (NAT) of the received IP address.

According to still another preferred embodiment the local gateway function may include the functionality of coordinating with the (e)NodeB on the usage of local IP traffic breakout. More specifically, the local gateway function may trigger the (e)NodeB for handling of local traffic. On the one hand the decision function may relate to the usage of local breakout for uplink traffic. Optionally, this can be part of the (e)NodeB. Alternatively, this part of the decision function may be implemented in the L-GW, but then the (e)NodeB must interrogate this decision function to perform the correct uplink routing. On the other hand the decision function may, additionally or alternatively, relate to the routing of downlink traffic, i.e. whether downlink traffic is directly routed to the (e)NodeB or via the extension tunnel.

With respect to charging issues it may be provided that the local gateway function includes a traffic monitoring and reporting function. For instance, this function may be required in case no flat rate charging is performed. When the User Equipment is located in a Macro-cell (where a differentiated charging- and/or policy-control is needed) the charging/policy control may be handled by the PDN-Gateway (in EPS case) or by the GGSN (in GPRS case) as usual. Regarding QoS for “LIPA/SIPTO traffic”, the argument is analogous to charging and policy-control, namely that no special QoS provisioning is required.

With respect to a beneficial (e)NodeB configuration it may be provided that the (e)NodeB functionality is enhanced to provide the user equipment's access states for the cell(s) served by the (e)NodeB to the local gateway function.

With respect to IP address handling, there are basically two different implementation possibilities. According to a first implementation a User Equipment gets assigned an individual IP address for each PDN connection (e.g. to the local network and to the operator network). According to a second alternative implementation, a User Equipment gets assigned only one IP address for several different connections to PDNs (e.g. the local network and the operator network). More specifically, in the case of two separate APNs (one for LIPA/SIPTO and one for non-LIPA/SIPTO traffic) it may be provided that the UE gets assigned two IP addresses (one for each PDN connection), wherein the IP address for LIPA/SIPTO APN is assigned by the local gateway function, and the IP address for non-LIPA/SIPTO APN is assigned by the PDN gateway or the GGSN, respectively. In case of LIPA/SIPTO APN the following may apply: In case the UE is local, packet routing at the (e)NodeB/L-GW may be performed based on known mapping between radio bearers and S1 bearers linked to the respective PDN connection (which are shortcut to the L-GW). In case the UE is non-local, packet routing may be performed via the PDN-Gateway/GGSN in the core network over the extension tunnel. It is to be noted that the L-GW knows about the fact that the UE is not connected to the respective (e)NodeB either due to co-location of these functions or via a dedicated communication channel.

In case of non-LIPA/SIPTO APN the following may apply: In case the UE is local, packet routing at the (e)NodeB/L-GW may also be performed based on known mapping between radio bearers and S1 bearers linked to the respective PDN connection. However, here the usual handling occurs, i.e. routing to S-GW (Serving-Gateway) via S1 bearers. In case the UE is non-local, there is no impact and IP packet handling follows the usual standard procedure.

IP packet handling for the case of one APN for LIPA/SIPTO and non-LIPA/SIPTO traffic may be based on the following considerations: The UE gets assigned only one IP address by the PDN gateway/GGSN which is used for all traffic. The local gateway function has one or more IP address(es) assigned for NATting purposes. In this context it is to be noted that if one and the same APN is used for LIPA/SIPTO traffic and non-LIPA/SIPTO traffic, the technical limitations of NAT (Network Address Translation) apply. In case the UE is local, there is no difference in IP packet handling for LIPA/SIPTO and non-LIPA/SIPTO traffic. The packet routing in uplink at the (e)NodeB is based on routing policies (e.g. based on destination IP address or identities linked to the UE). Traffic matching the LIPA/SIPTO routing policies is routed to the L-GW, traffic not matching is routed to the S-GW (as usual). In the downlink packets are routed to the (e)NodeB. Again, it is to be noted that the L-GW knows about the UE's connection status with the (e)NodeB.

In case the UE is non-local, LIPA/SIPTO traffic is routed via the PDN gateway/GGS in the core network over the extension tunnel. The L-GW knows about the fact that the UE is not connected to the respective (e)NodeB. Again, there is no impact for non-LIPA/SIPTO traffic, where the usual standard procedures apply.

Advantageously, in case terminating local IP and/or Internet traffic arrives at the User Equipment and the User Equipment is in sleep or idle mode, the traffic may be tunnelled to the PDN-Gateway/GGSN, and paging procedures may be executed in the mobile operator network in order to locate and wake up the UE.

There are several ways how to design and further develop the teaching of the present invention in an advantageous way. To this end it is to be referred to the patent claims subordinate to patent claims 1 and 21 on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will we explained. In the drawing

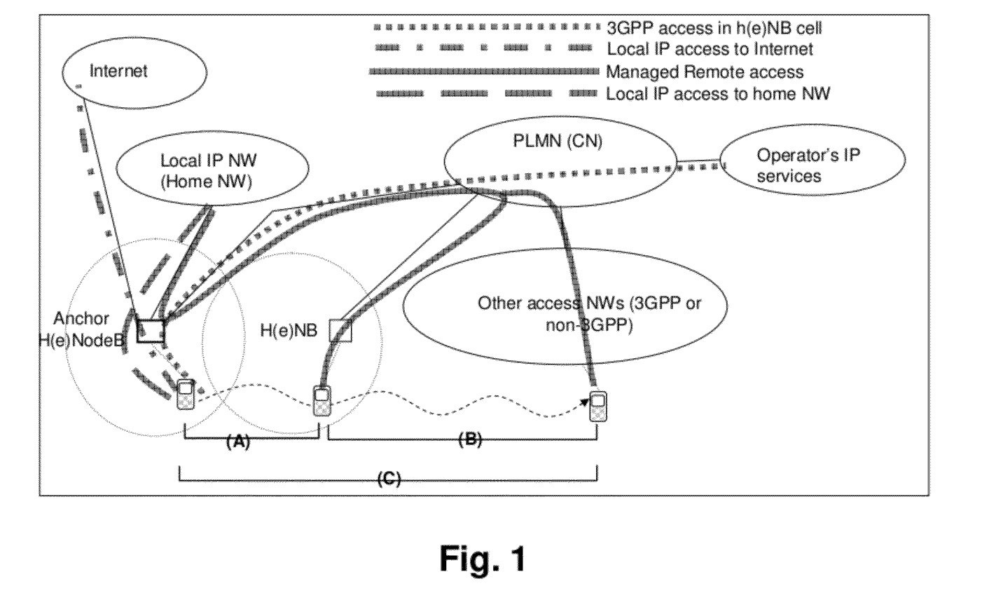

FIG. 1 is a diagram schematically illustrating different target connectivity scenarios,

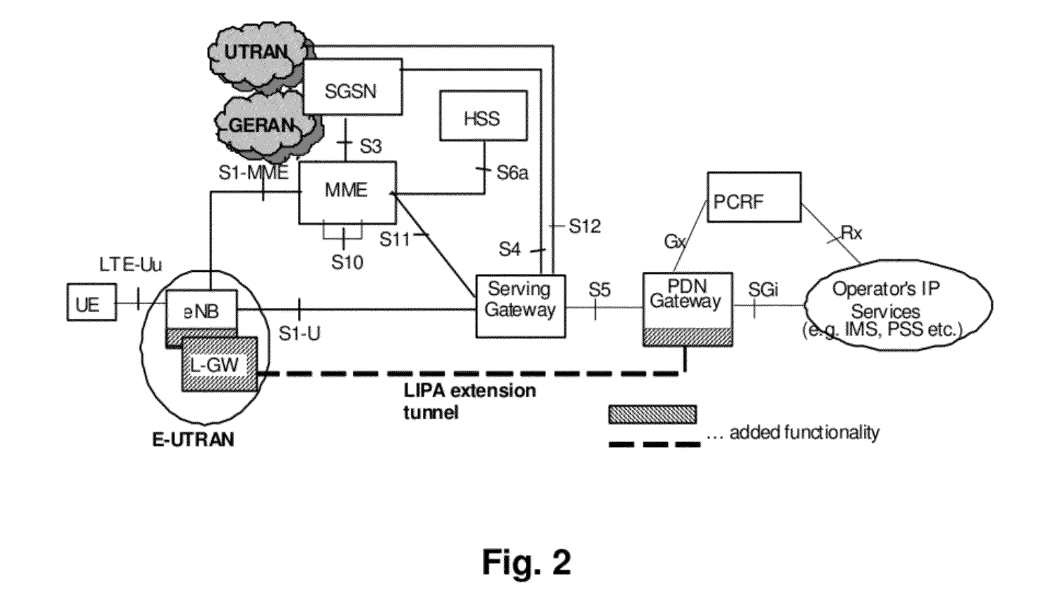

FIG. 2 is a diagram schematically illustrating a first embodiment of a system according to the present invention in a non-roaming architecture for 3GPP accesses,

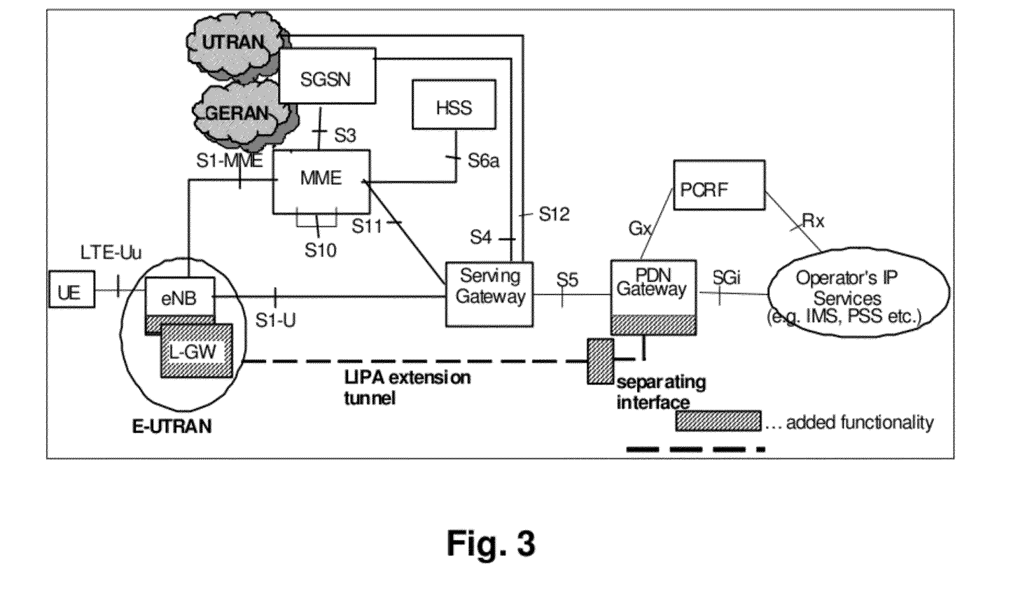

FIG. 3 is a diagram schematically illustrating a second embodiment of a system according to the present invention in a non-roaming architecture for 3GPP accesses,

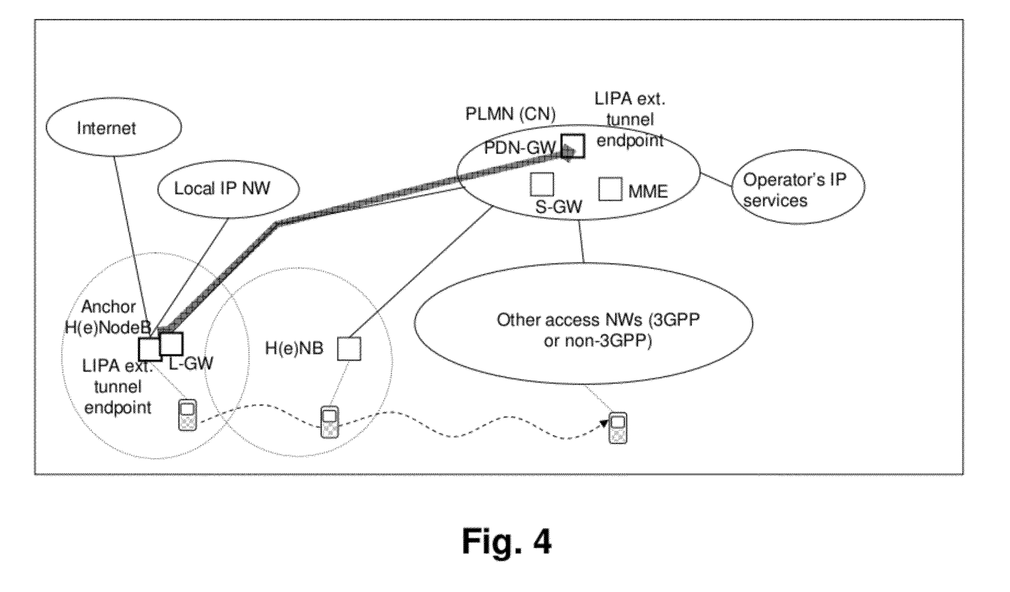

FIG. 4 is a diagram schematically illustrating an embodiment of a system according to the present invention for LIPA with home (e)NodeB,

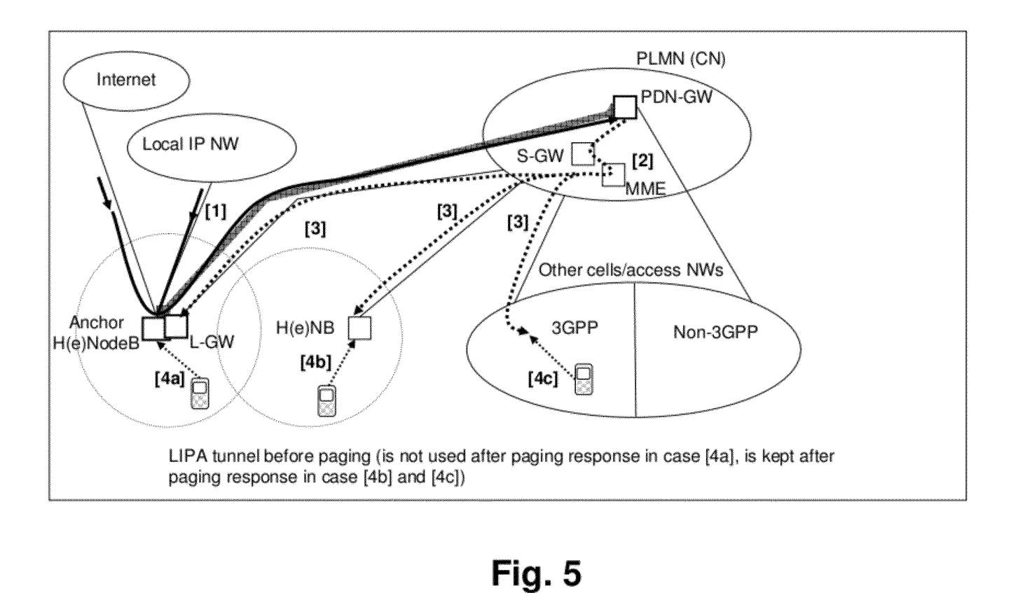

FIG. 5 is a diagram schematically illustrating an embodiment of a system according to the present invention with the UE being in idle mode,

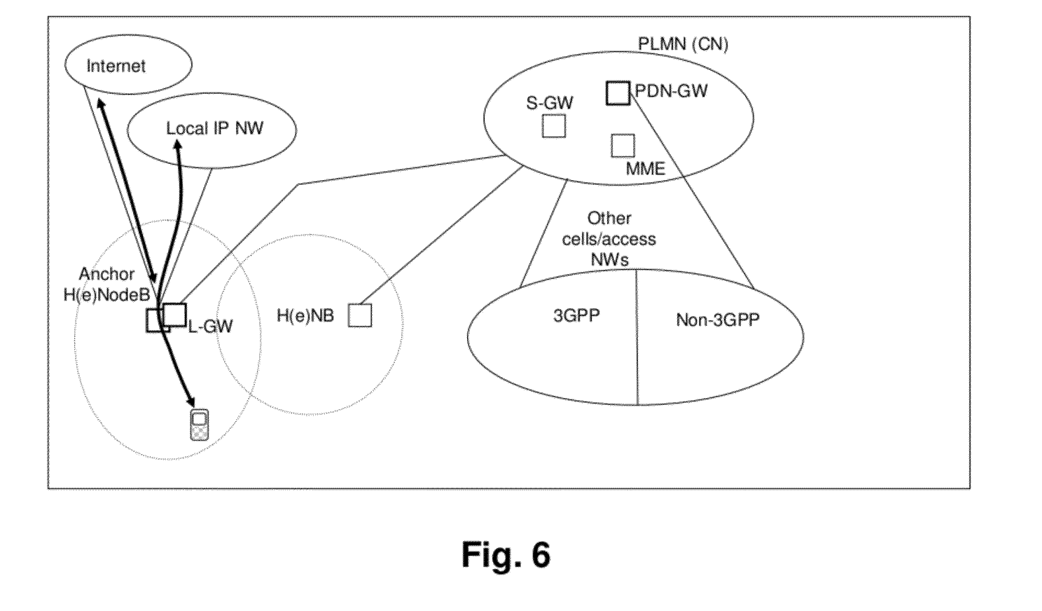

FIG. 6 is a diagram schematically illustrating an embodiment of a system according to the present invention with the UE being in active mode and being located in/served by the anchor home (e)NodeB cell, and

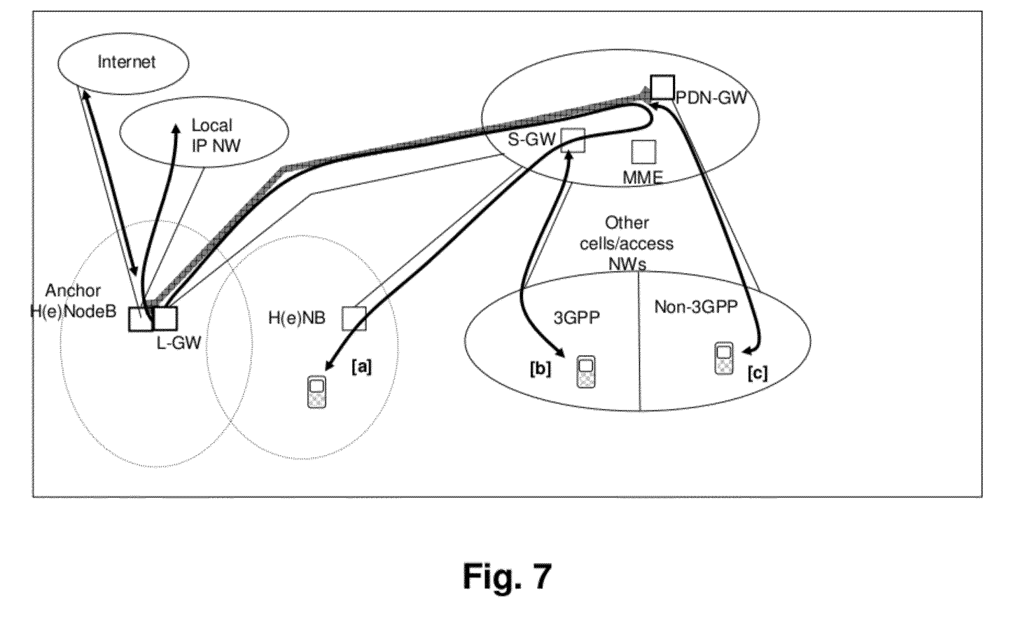

FIG. 7 is a diagram schematically illustrating an embodiment of a system according to the present invention with the UE being in active mode, but not located in/served by the anchor home (e)NodeB cell.

In the entire description pertaining to FIG. 1-7, for the sake of simplicity, only the term “(e)NodeB” is used. This term is to be understood as an abbreviation for the terms “(evolved) NodeB”, “Home-(e)NB”, “H(e)NB”, “Node B”, “NB”, “HomeNB”, and “HNB”.

The term LIPA (Local IP Access) is used in the following generally for access to an IP network connected locally with the (e)NodeB (here called “LIPA for local traffic”) and also for Internet access, referred to as SIPTO (Selected IP Traffic Offload), where the Internet is reachable directly from the (e)NodeB via some local ISP, thus avoiding the operator core network. Particular embodiments of the present invention may apply preferably either for LIPA (i.e. for local traffic) or for SIPTO (i.e. for Internet traffic), or equally for both.

Although the embodiments of the present invention described in connection with the drawing are related to evolved UTRAN (LTE) radio access, it is to be understood, that the embodiments would equally apply to UTRAN radio access (3G).

FIG. 1 schematically illustrates a system with two home (e)NodeBs, one of which (the left one) functions as anchor home (e)NodeB. In this connection the term “anchor” is employed to denote the home (e)NodeB the UE is currently associated with. The UE may perform handovers to other cells, for instance to another home (e)NodeB, as indicated by (A), from there to other access networks (either 3GPP or non-3GPP), as indicated by (B), or directly from the anchor home (e)NodeB to other access networks, as indicated by (C).

FIG. 1 illustrates different target connectivity scenarios. For instance, in case the UE is connected to the anchor home (e)NodeB the dash-dotted line indicates local IP access to the Internet, the dashed line indicates local IP access to the UE's home network, and the dotted line indicates 3GPP access to the mobile operator's core network—PLMN (CN), Public Land Mobile Network (Core Network)—and to the associated operator's IP services.

In case the UE has performed a handover to another home (e)NodeB or to another access network, the so-called Managed Remote IP access to the UE's local IP network is realized via the PLMN (CN), as indicated by the solid line. With respect to supporting local IP connectivity it is important to guarantee that a continuous service is supported by the target architecture, even if UE mobility (of type A, B or C) happens. Furthermore, it should offer flexible control by the operator.

FIG. 2 schematically illustrates a first embodiment of a system according to the present invention in a 3GPP EPS architecture. The general aspects of this architecture are well known to skilled persons, therefore a detailed description of the underlying architecture can be omitted here and only the architectural extension according to the present invention will be described in detail. As can be obtained from FIG. 2, a UE is connected via the LTE-Uu interface to a home (e)NodeB. According to prior art traffic is routed via the S1 interface to the Serving-Gateway (S-GW), and from there via the S5/S8 interface to the PDN-Gateway. Depending on the respective APN, traffic is routed from there either to the operator's IP services, e.g. IMS (IP Multimedia Subsystem), PSS (Packet Streaming Service), etc., or to other networks like the Internet, corporate networks, or the like (not shown).

According to the present invention a local gateway function (L-GW) is provided that, according to the embodiment shown in FIG. 2, is collocated with the home (e)NodeB. Furthermore, an extension tunnel is established between the L-GW and the PDN-Gateway as terminating endpoints. The functionality of the L-GW and the extension tunnel in various application scenarios will be described in connection with FIGS. 5-7.

FIG. 3 is a diagram that illustrates basically the same architecture for 3GPP accesses as shown in FIG. 2. The only difference is related to the extension tunnel establishment. In contrast to the embodiment of FIG. 2, where the PDN-Gateway constitutes one endpoint of the extension tunnel, a separate functional entity is provided in the embodiment of FIG. 3 as extension tunnel endpoint. The functional entity is equipped with a separating interface that communicates with the PDN-Gateway.

FIG. 4 is a diagram schematically illustrating an embodiment of the present invention. Basically, FIG. 4 shows the same network architecture as FIG. 1 with the same handover scenarios of the UE indicated by the dashed line. According to the present invention a Local Gateway function (L-GW) is provided that, in the embodiment shown in FIG. 4, is collocated with the anchor home (e)NodeB. The L-GW and the PDN-Gateway of the mobile operator network (PLMN (CN)) constitute the two terminating endpoints of the LIPA/SIPTO extension tunnel.

Principally, all the handling is per UE, i.e. the L-GW checks for instance if LIPA/SIPTO is allowed, it performs IP address handling, traffic routing, etc. However, it is also possible to use only one LIPA/SIPTO extension tunnel between L-GW and PDN-Gateway for several UEs.

The method according to the present invention is able to support two principal variants for APN usage, which are separate APNs for LIPA/SIPTO or a common APN for LIPA/SIPTO and non-LIPA/SIPTO traffic, as well as their combination. It is to be noted that there is no principal limitation of number of APNs in the base architecture and its functionality, and thus further differentiation of APNs, e.g. one for non-LIPA/SIPTO traffic, one for local traffic (LIPA) and a third for traffic to/from the Internet (SIPTO) is foreseen and is a straightforward extension.

FIGS. 5-7 show tunnels and other configuration for idle and active mode, both within the anchor home (e)NodeB cell and outside. It is to be noted that although the home (e)NodeB case is illustrated and explained in detail, application scenarios with macro-cell (e)NodeBs are possible in an analogous way.

FIG. 5 illustrates the situation with terminating traffic arriving while the UE is in idle mode somewhere in 3GPP access. It is to be noted that in non-3GPP access the definition of idle mode generally does not exist; if the UE is in non-3GPP access then the PDN-Gateway knows about the detailed location and thus no paging is required. In FIG. 5, step [1] illustrates terminating local IP or Internet traffic arriving at the UE that is tunnelled via the extension tunnel, which is provided according to the present invention to the PDN-Gateway (PDN-GW) of the PLMN (CN). Step [2] indicates the paging procedure via interfaces S5/S8/S11. In EPS architecture the paging procedure is executed by the MME (Mobility Management Entity). Step [3] indicates the paging to the different existing cells via the S1 interface. It is to be noted that no assumptions on special assignment of Tracking Areas to home (e)NodeBs is required.

Step [4] illustrates the respective response of the UE to the paging in different scenarios. As illustrated in step [4a], in case the UE is located in the anchor home (e)NodeB cell, the home (e)NodeB informs the L-GW to avoid the extension tunnel and to route traffic directly from the L-GW to the UE. In case the UE is located in another home (e)NodeB cell, as illustrated in case [4b], the home (e)NodeB informs the L-GW to use the extension tunnel. Consequently, traffic is tunnelled from the L-GW to the PDN-Gateway, and from there, as usual, via the S-GW to the home (e)NodeB where the UE is located. In case the UE is located in other cells of 3GPP access, illustrated in case [4c], communication is similar to the [4b] case, and the home (e)NodeB informs the L-GW to use the extension tunnel.

FIG. 6 depicts a scenario in which the UE is in active mode and located in the cell of the anchor home (e)NodeB. In this case the L-GW will not trigger the establishment of an extension tunnel to the PDN-GW. Instead, packet routing is directly performed by the home (e)NodeB and the L-GW to and from e.g. the Internet and local IP network.

FIG. 7 illustrates the active mode scenario, when the UE is not located in the cell of the anchor home (e)NodeB. According to scenario [a] the UE is either located in another home (e)NodeB cell, or in the macro 3GPP access (scenario [b]) or in non-3GPP access (scenario [c]). In any of the three cases ([a], [b] or [c]) an extension tunnel is established between the L-GW and the PDN-Gateway and traffic is tunnelled. In cases [a] and [b] traffic arriving at the PDN-Gateway is forwarded via the S-GW; in case the UE is located in non-3GPP access (case [c]) the traffic is directly routed by the PDN-Gateway and S-GW is not involved.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. System for supporting local IP connectivity for an (e)NodeB, said system including a mobile operator network with a PDN-Gateway or a GGSN, and at least one User Equipment (UE) that is associated with said (e)NodeB,
characterized in that a local gateway function (L-GW) is provided for said (e)NodeB, wherein an extension tunnel is established between said local gateway function (L-GW) and said PDN-Gateway or said GGSN of said mobile operator network.

2. System according to claim 1, wherein said extension tunnel is terminated within said PDN-Gateway or within said GGSN as endpoint.

3. System according to claim 1, wherein said extension tunnel is terminated in a functional entity outside of said PDN-Gateway, said entity interfacing with said PDN-Gateway or said GGSN.

4. System according to claim 1, wherein said extension tunnel is established each time a PDN connection is established between a User Equipment (UE) and said PDN-Gateway or said GGSN via said (e)NodeB.

5. System according to claim 1, wherein said PDN-Gateway or said GGSN includes a decision function for performing said extension tunnel establishment only in case of connection establishment to a PDN with an APN that matches predefined criteria for local traffic.

6. System according to claim 1, wherein said extension tunnel between said local gateway function (L-GW) and said PDN-Gateway or said GGSN is established and used for several User Equipments (UE) concurrently.

7. System according to claim 1, wherein said local gateway function (L-GW) is collocated with said (e)NodeB.

8. System according to claim 1, wherein said (e)NodeB is a Home (e)NodeB or a Macro-cell (e)NodeB.

9. System according to claim 1, wherein said local gateway function (L-GW) includes the functionality of routing traffic to and from external packet data networks, in particular to and from the Internet and said User Equipment's (UE) home network.

10. System according to claim 1, wherein said local gateway function (L-GW) includes the functionality of tunnelling IP packets through said extension tunnel to and from said PDN-Gateway or said GGSN.

11. System according to claim 1, wherein said local gateway function (L-GW) includes the functionality of allocating said User Equipment (UE) an IP address and of conveying said allocated IP address to said PDN-Gateway or said GGSN.

12. System according to claim 1, wherein said local gateway function (L-GW) includes the functionality of receiving an IP address allocated to said User Equipment by said PDN-Gateway or said GGSN and performing a network address translation of said received IP address.

13. System according to claim 1, wherein said local gateway function (L-GW) includes the functionality of coordinating with said (e)NodeB on the usage of local breakout.

14. System according to claim 1, wherein said (e)NodeB includes a decision function on the usage of local breakout for uplink traffic.

15. System according to claim 1, wherein said local gateway function (L-GW) includes a decision function on the routing of downlink traffic.

16. System according to claim 1, wherein said local gateway function (L-GW) includes a traffic monitoring and reporting function.

17. System according to claim 1, wherein said (e)NodeB is configured to provide to said local gateway function (L-GW) said User Equipment's (UE) access state for the cells served by said (e)NodeB.

18. System according to claim 1, wherein said User Equipment (UE) gets assigned an individual IP address for each connection to a packet data network.

19. System according to claim 1, wherein said User Equipment (UE) gets assigned only one IP address for several different connections to packet data networks.

20. System according to claim 1, wherein, in case terminating local IP and/or Internet traffic arrives at said User Equipment (UE) and said User Equipment (UE) is in idle mode, said traffic is tunnelled to said PDN-Gateway or GGSN and paging procedures are executed in said mobile operator network.

21. Method for supporting local IP connectivity for an (e)NodeB, in particular for being executed in a system according to claim 1, wherein a mobile operator network with a PDN-Gateway or a GGSN is provided, and wherein at least one User Equipment (UE) is associated with said (e)NodeB,
characterized in that a local gateway function (L-GW) is provided for said (e)NodeB, wherein an extension tunnel is established between said local gateway function (L-GW) and said PDN-Gateway or said GGSN of said mobile operator network.
